(19) United States
(12) Patent Application Publication
(10) Pub. No.: US 2016/0234520 A1
(43) Pub. Date: Aug. 11, 2016

(54) EFFICIENT PROGRESSIVE JPEG DECODE METHOD

(71) Applicant: ENTROPIC COMMUNICATIONS, LLC, San Diego, CA (US)

(72) Inventor: Anurag GOEL, Hyderabad (IN)

(21) Appl. No.: 15/022,348

(22) PCT Filed: Sep. 16, 2013
(86) PCT No.: PCT/US13/59899

§ 371 Date: Mar. 16, 2016

(51) Int. Cl. H04N 19/44; H04N 19/176; H04N 19/625; H04N 19/70; H04N 19/167

(52) U.S. Cl. CPC H04N 19/44; H04N 19/70; H04N 19/167; H04N 19/625; H04N 19/176

(57) ABSTRACT

A method, system, and computer program reduce the memory and computation resources required to decode a progressively encoded JPEG image (52). A sub-sampled approximation of a JPEG image is decoded (54) and an IDCT operation is performed, such as 2×2 or 4×4 or 8×8 IDCT (FIGS. 6, 7, 8, 12), which aids the reconstruction of sub-sampled approximation of a JPEG image. The sub-sampled approximation of a JPEG image is upscaled (46) by using an upscaling operation. An image output buffer is used as an intermediate buffer for storing DCT coefficients for the JPEG bitstream being decoded from a file and decoding of a JPEG bitstream which is being streamed over a network.

### RELATED APPLICATIONS

The present application is related to co-pending patent application Serial No. PCT/US2013/______ filed on to be determined entitled “A PROGRESSIVE JPEG BITSTREAM TRANSCODER AND DECODER”; also related to co-pending patent application Serial No. PCT/US2013/______ filed on to be determined and entitled “PARALLEL DECODE OF A PROGRESSIVE JPEG BITSTREAM”.

### FIELD

The disclosed method and apparatus relates to communication systems, and more particularly, embodiments related to reduce the memory and computation resources required to decode an image bitstream encoded in progressive JPEG mode.

### BACKGROUND INFORMATION

The Joint Picture Experts Group (JPEG) Standard, encodes an image as successive approximations of a JPEG image. A JPEG image encoded in such a manner is termed as a Progressive JPEG bitstream. A Progressive JPEG bitstream is transmitted by sending successive approximations of a JPEG image over a network in a succession. The JPEG Standard suggests storing entropy decoded Discrete Cosine Transform coefficients for all the components in memory for an image bitstream encoded in progressive JPEG Mode. As soon as a subset of frequency coefficients of all the components as partitioned by an image or JPEG encoder becomes available, the same are stored and decoded and an image that is a coarse approximation of an original image is displayed. Discrete Cosine Transform (DCT) coefficients, which have been decoded are stored as they are required for decoding an improved approximation of an image after a remaining portion of the bitstream has been received. As more frequency coefficients of all the components as partitioned by image/JPEG encoder become available, they are stored and decoded along with previously stored frequency coefficients and an image, which is an improvement over the previous coarse approximation of an original image, is displayed.

JPEG image decoding as described above requires an intermediate memory of the order of image_width*image_height*no_of_components*frequency_coefficient_num_bytes, i.e., W*H*N*2, for storing DCT coefficients of all image components. No_of_components is the total number of different components, which when combined, represent a multi-component JPEG image; for example, a YUV JPEG image consists of three components Y, U and V. frequency_coefficient_num_bytes is the number of bytes required to represent a frequency coefficient. The JPEG library developed by the independent JPEG group requires so much intermediate memory for decoding a progressively encoded JPEG bitstream.

If the original image dimensions are 2K*2K, then approx 2K*2K*3*2 bytes of memory are needed for YUV 4:4:4 color format, which is approximately 24 MB. Successive improvements in an image require repeated Inverse Discrete Cosine Transform (IDCT) computation, hence increasing computation resources by a factor proportional to the number of successive improvements.

Researchers have proposed various solutions toward efficient implementation of progressive JPEG decoder.

U.S. Pat. No. 7,313,281B2, entitled “Method and Related Apparatus for JPEG Decoding” to Chi-Cheng Ju, et. al., teaches decoding each of the scans into partial decoded pixel and summing each newly generated partial decoded pixel.

U.S. Patent Application No. 2003/0091240A1, entitled “Method and Apparatus for Progressive JPEG Image Decoding” to Chi-Cheng Ju, et. al., and U.S. Patent Application No. 2007/0098275A1, entitled “Method and Apparatus for Progressive JPEG Image Decoding” to Kun-Bin Lee, teach decoding a progressive JPEG image by dividing each of the scans into multiple regions and then decoding the regions individually. Finally, the decoded coefficients of the current decoding region of all scans are outputted in order to construct a portion of the image data.

U.S. Patent Application No. 2005/0008234A1, entitled “Process and Functional Unit for the Optimization of Displaying Progressively Coded Image Data” to Uwe-Erik Martin, teaches a method for optimizing the downloading of progressively coded image data. The wait times between the time points of directly consecutive decoding steps are calculated using statistical image quality parameters of received partial image data in such a manner that the decoding steps, which do not lead to perceptible improvement in the quality of a reconstructed image are suppressed.

U.S. Patent Application No. 2006/0067582 A1, entitled “Progressive JPEG Decoding System” to Mi Michael Bi, et. al., teaches a method in which DCT coefficients in a particular decoded scan are classified into two categories, namely, most significant DCT coefficients and least significant DCT coefficients. The least significant DCT coefficients are not stored directly in the memory. They are binarized and represented by either “0” or “1” indicating if they are zero or non-zero coefficients. The binarized bitmap for the least significant DCT coefficients and the actual values of most significant DCT coefficients are stored in the memory and, thus, the overall memory requirements are significantly reduced.

U.S. Patent Application No. 2008/0130746A1, entitled “Decoding a Progressive JPEG Bitstream as a Sequentially Predicted Hybrid Video Bitstream” to Soroushian, et. al., teaches generating an intermediate bitstream by parsing a JPEG bitstream carrying a picture. The intermediate bitstream generally includes one or more encoded frames each representing a portion of the picture. A second circuit may be configured to (i) generate one or more intermediate images by decoding the encoded frames, and (ii) recreate the picture using the intermediate images.

U.S. Patent Application No. 2008/0310741A1, entitled “Method for Progressive JPEG Image Decoding” to Yu-Chi Chen, et. al., describes a method of using a non-zero history table and a sign table of each Variable Length Decoding (VLD) result, which are recorded and used as a reference for decoding the next scan layer. The decoded coefficients are no longer directly stored in a memory to save the memory space.

U.S. Patent Application No. 2009/0067732A1, entitled “Sequential Decoding of Progressive coded JPEGS” to Sukesh V. Kaithakapuzha, teaches progressive scan encoded JPEGS are decoded sequentially on a Minimum Coded Unit (MCU) basis. Address Pointers are used to index into each scan, and coded data from each scan is outputted to form an entropy decoded MCU.

Each of these attempts to solve the problem addressed by this disclosure have the similar shortcoming of increased memory usage, and increased decode latency.

Secondly the prior art references perform IDCT, data copy and color format conversion, such as YCbCr to RGB, for entire MCU/data unit for every reconstruction of an approximation of an image.

### SUMMARY

The problem solved by this disclosure is to reduce the memory and computation resources required to decode an image bitstream encoded in progressive JPEG mode. For an understanding of the features in this disclosure, a brief description of the state of the art is provided.

FIG. 1 shows the major operations involved in a typical prior art JPEG encoder 10. A color image is generally represented as a mixture of various color component images, for example, a color image may be represented by a combination of a Red, Green and Blue color component image. For higher compression and efficient implementation of various use cases a RGB source image is generally pre-processed to convert it into a YUV source image. Source Image Data, which is an input to JPEG Encoder may or may not be a multiple component image, for example a YUV source image is a three component image. JPEG encoder 10 illustrates encoding of a single component source image. Typically, similar operations as performed for encoding of a single component source image are performed by JPEG encoder 10 for encoding multiple component source image (such as shown in FIG. 1A).

Encoder 10 partitions the source image data into MCU/data unit and performs the encoding operation on each MCU/data unit. A data unit is 8×8 block of samples of one component in DCT-based processes.

FDCT block performs a mathematical transformation of the data unit to convert a block of samples into a corresponding block of original DCT coefficients. One of the DCT coefficients is referred to as the DC coefficient and the rest are the AC coefficients.

JPEG Encoder 10 selects a Quantization Table selected from Table Specifications block. Quantizer block quantizes DCT coefficients by using a specific quantization value for each positional DCT coefficient. Positional quantization value is obtained from Quantization Table.

Iqᵤᵥ=round(Iᵤᵥ/Quᵥ)

Iqᵤᵥ—Quantized DCT coefficient at frequency (u,v), Iᵤᵥ—DCT coefficient at frequency (u,v), Qᵤᵥ—Quantization value at frequency (u,v).

After quantization, and in preparation for entropy encoding, JPEG Encoder 10 encodes the quantized DC coefficient as the difference from the DC term of the previous block in the encoding order (defined in the following), as shown in FIG. 2A.

After quantization, and in preparation for entropy encoding, the quantized AC coefficients are converted to a stream of coefficients as per the zigzag order. The zigzag sequence is specified in FIG. 2B.

Entropy Encoder block (FIG. 1) encodes the quantized DCT coefficients by performing either of the two entropy coding methods, i.e., Huffman or Arithmetic coding. Corresponding entropy encoding tables are selected from Table specifications block. Entropy Encoder block may format the encoded stream as progressive JPEG bitstream or as a sequential JPEG stream.

A progressive JPEG encoder typically stores all the quantized DCT coefficients of an image in an intermediate image buffer that exists between the Quantizer block and the Entropy Encoder block. There are two procedures, i.e. spectral selection and successive approximation, by which the quantized coefficients in the buffer may be partially encoded within a scan, the scan contains data from all the MCU's/data units present in an image component.

Reference is now made to FIG. 1B. In spectral selection, the zigzag sequence of DCT coefficients is segmented into frequency bands. The same frequency bands from all the MCUs/data units are encoded sequentially to form a scan. DC coefficients are always coded separately from AC coefficients. DC coefficients scan may have interleaved blocks from more than one component. All other scans will have only one component.

Successive approximation is a progressive coding process in which the coefficients are coded with reduced precision. DCT coefficients are divided by a power of two before coding.

An encoder or decoder implementing a full progression uses spectral selection within successive approximation. As indicated above, FIG. 1B illustrates the spectral selection and successive approximation.

FIG. 3 shows the major operations involved in a JPEG decoder 14. Progressive JPEG decoder typically stores all quantized DCT coefficients of an image before decoding DCT coefficients of an image present in separate scans. As soon as a subset of DCT coefficients as partitioned by JPEG encoder becomes available, it is decoded for all image components and image is sent for display. A maximum number of times a new approximation of an image can be displayed may be equal to the minimum number of scans of an image component.

JPEG Decoder parses the compressed JPEG bitstream and determines if the JPEG bitstream to be decoded is a Progressive, Sequential, Hierarchical or lossless JPEG bitstream. Entropy Decoding, i.e., Huffman or Arithmetic Decoding, and Quantization tables to be used for decoding are obtained from the compressed bitstream.

Entropy Decoder block performs an Entropy Decoding operation on compressed bitstream using Entropy Decoding Tables specified in the bitstream. Entropy Decoding Table is obtained from the Table Specification block, on the basis of information parsed from the JPEG bitstream. Typical progressive JPEG Entropy decoder entropy decodes a particular scan completely before proceeding to decode the next scan. In this manner, progressive Entropy Decoder entropy decodes all the scans, and hence entropy decodes all image components. Entropy decoder block generates quantized DCT coefficients.

An intermediate Image Buffer exists between the Quantizer block and the Entropy Decoder block. Progressive JPEG entropy decoder stores all the quantized DCT coefficients of an image in an intermediate image buffer.

Dequantizer block (FIG. 3) performs a dequantization operation using Dequantization Tables specified in the bitstream. De-Quantization Table is obtained from the Table Specification block, on the basis of information parsed from the JPEG bitstream.

Rᵤᵥ=Iqᵤᵥ*Qᵤᵥ

Rᵤᵥ—Inverse Quantized DCT coefficient at frequency (u,v)
Iqᵤᵥ—Entropy decoded DCT coefficient at frequency (u,v)
Qᵤᵥ—Quantization value at frequency (u,v)

If successive approximation was used by Progressive JPEG Encoder then JPEG decoder multiplies the quantized DCT coefficients by a power of two before computing the IDCT. Power of two to be used is obtained from the encoded bitstream.

IDCT block performs an Inverse DCT operation on an 8×8 block of inverse quantized DCT coefficients to generate an 8×8 block of image samples of a particular image component.

JPEG Decoder decodes all MCUs/data units to form Reconstructed Image Data.

Decoding of a progressively encoded JPEG image usually shows successive improved approximations of an entire image, as shown in FIG. 4.

Decoding of a sequentially encoded JPEG image usually shows a row-by-row build-up of a final image, as shown in FIG. 5.

There are various uses, which require a JPEG Decoder to be present on Set Top Box (STB), which include:
Internet browsing on set top box;
Decode and display of JPEG images downloaded from internet/intranet, which may be wired or wireless or a combination thereof;
Decode and display of JPEG images shared via storage devices such as USB stick, USB hard disk, SATA hard disk, Flash, etc; and
Decode and display of JPEG images shared over relatively close distance wired or wireless channel such as Bluetooth, WI-FI etc.

JPEG images encoded for internet/intranet/Wide Area Network (WAN)/Local Area Network (LAN) or downloaded from internet/intranet/WAN/LAN may be available in JPEG progressive mode, hence, it is important for Set Top Box to support decoding of progressively encoded JPEG content. STBs have a limited amount of memory, hence it is essential that a reduced memory footprint be used for decoding of Progressive JPEG images.

Computational resources are becoming economical, and relatively more computation power is available. The computation resources of higher capability have propagated into almost all strata of society of developed, developing countries and to some extent in under developed countries. Resolution supported by digital cameras has also gone up considerably. However the same is not true for the bandwidth available to the consumers, hence, progressively encoded JPEG content is likely to become, and is becoming, available on internet.

The claimed embodiments reduce the memory and computation resources required to decode a progressively encoded JPEG image. The memory reduction is accomplished using at least one of the following: by decoding a sub-sampled approximation of a JPEG image and performing an IDCT operation, such as 2×2 or 4×4 or 8×8 IDCT, which corresponds to the sub-sampled approximation of a JPEG image; using an image output buffer as intermediate buffer for storing DCT coefficients for (i) when a JPEG bitstream is being decoded from a file and (ii) decoding of a JPEG bitstream which is being streamed over a network; upscaling of a sub-sampled approximation of a JPEG image by using an upscaling operation; decoding one image component at a time; using a single byte to store some of the frequency coefficients; non-storage of zero DCT coefficients; and non-storage of DCT coefficients of last non-zero scan of an Image component.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 shows a typical prior art JPEG encoder.

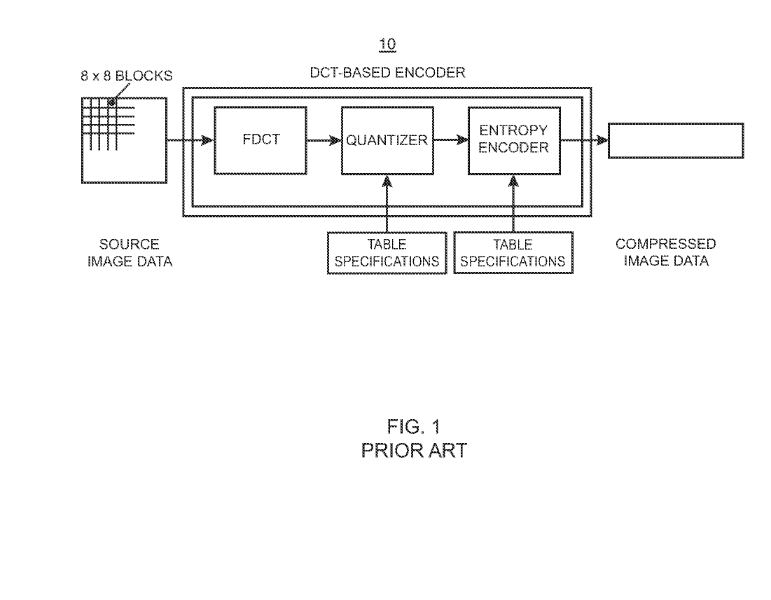

FIG. 1A shows a multi-component source image.

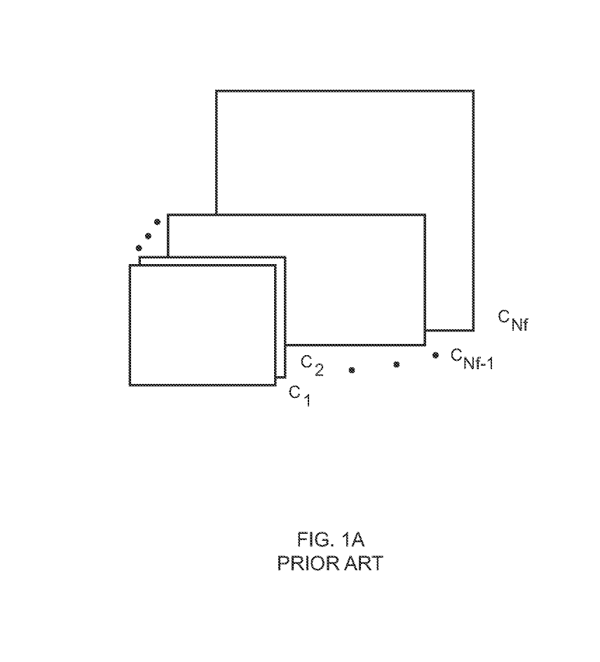

FIG. 1B illustrates progressive encoding with spectral selection shown on the left side, and successive approximation shown on the right side.

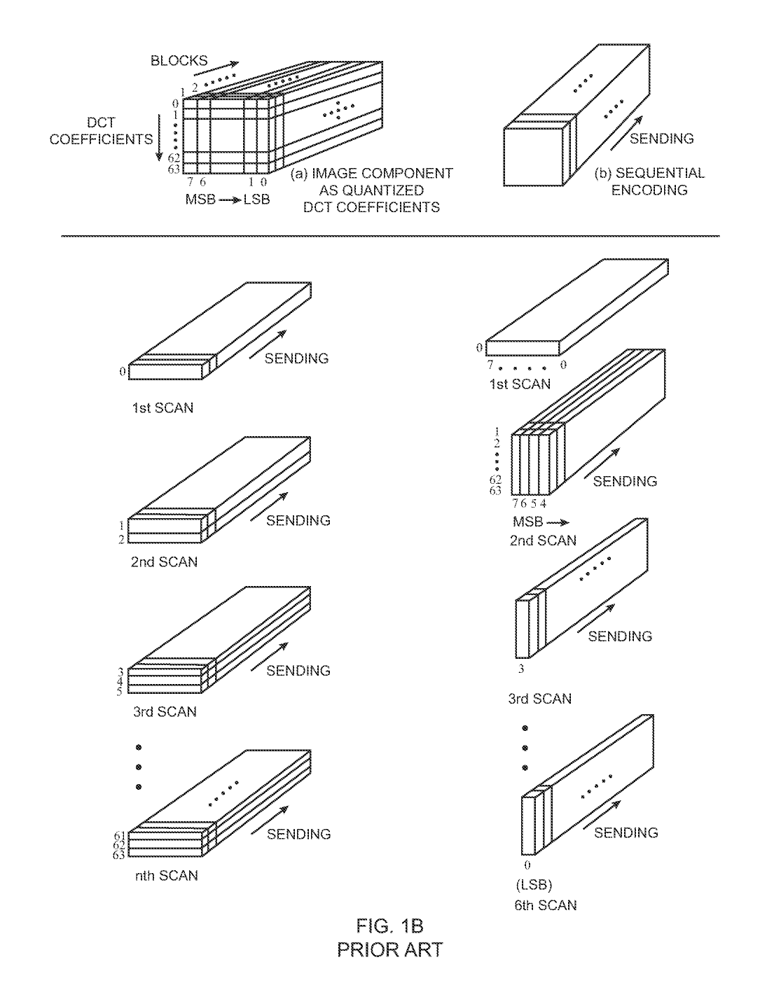

FIG. 2A shows how a prior art DC prediction is done.

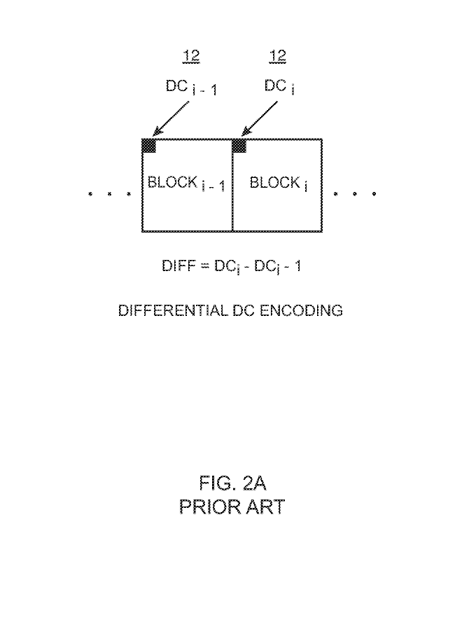

FIG. 2B shows the reordering of the DCT coefficients in a zigzag order.

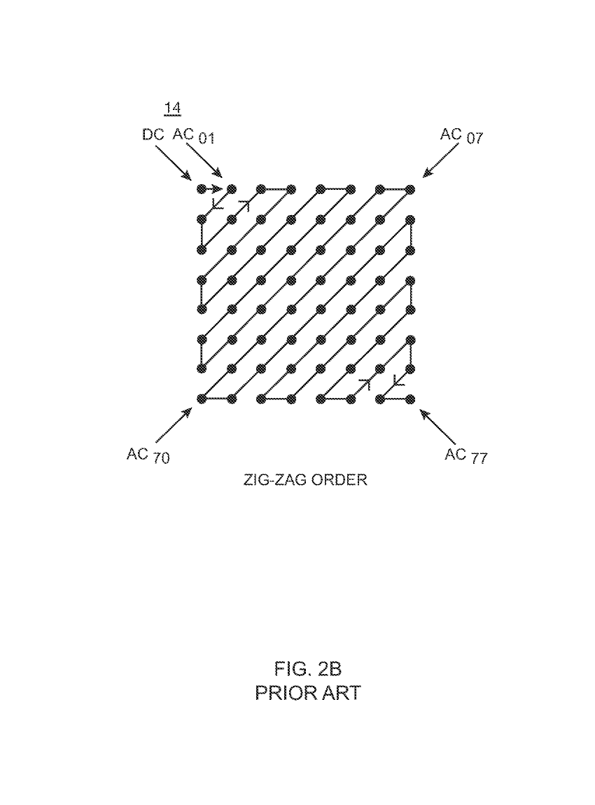

FIG. 3 shows a typical prior art JPEG decoder.

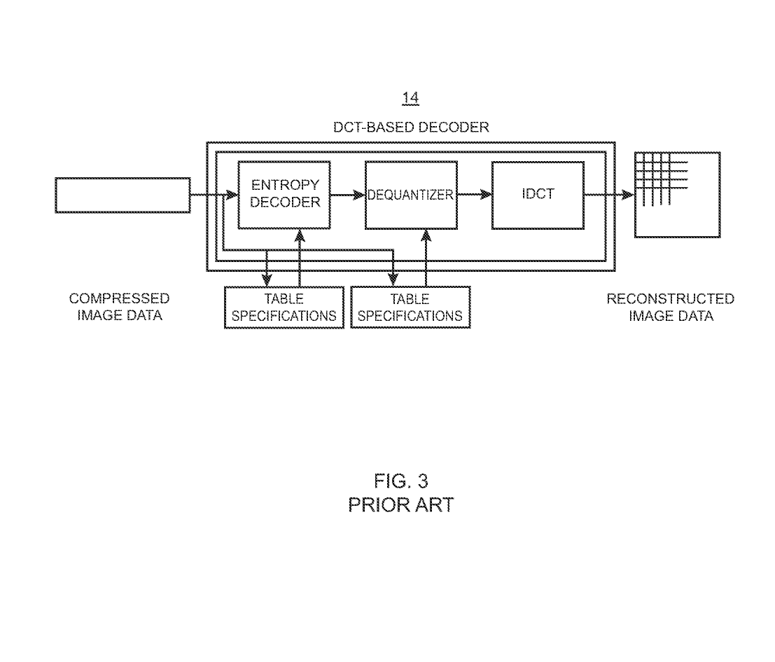

FIG. 3A illustrates system level flow of JPEG decoding in Set Top Box for one component.

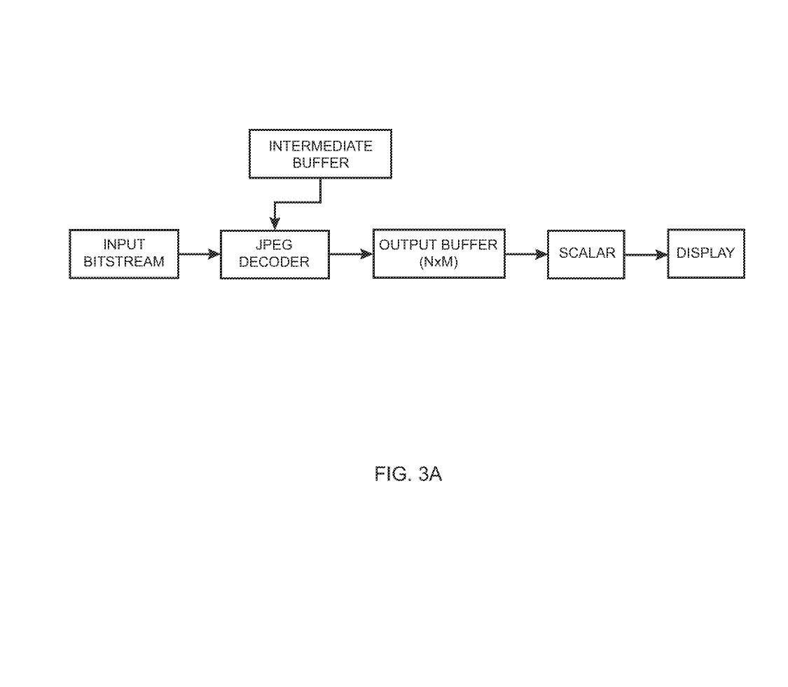

FIG. 4 depicts prior art progressive JPEG decoding.

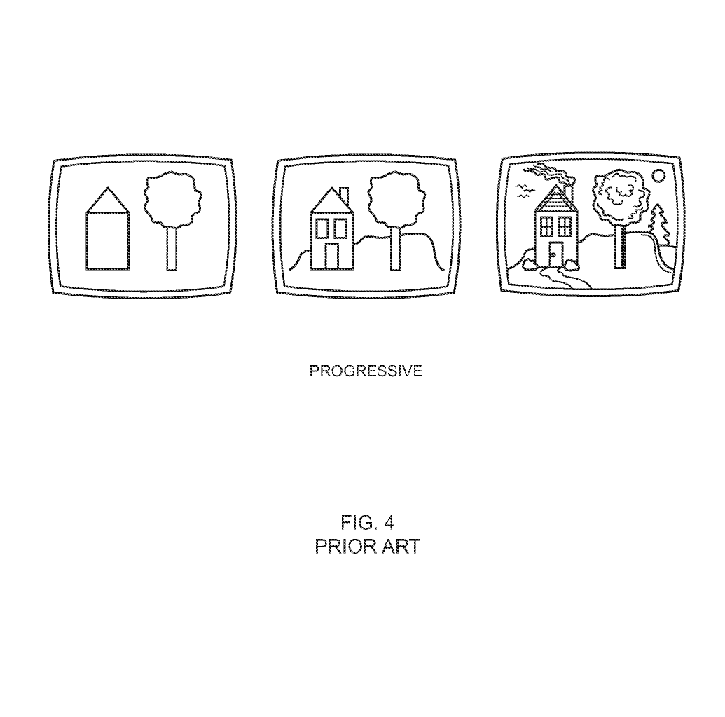

FIG. 5 depicts prior art sequential JEPG decoding.

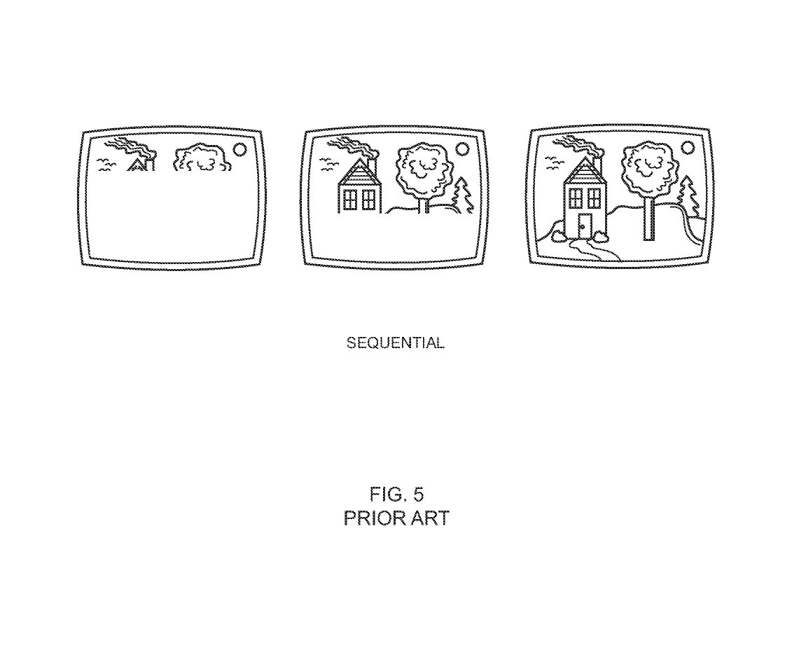

FIG. 6 shows a DC coefficient of each eight by eight (8×8) block of decoded frequency coefficients. Reconstruction of the same yields an N/8×M/8 approximation of a JPEG image.

FIG. 7 shows a 2×2 array of low frequency coefficients of each eight by eight (8×8) block of decoded frequency coefficients. Reconstruction of the same yields an N/4×M/4 approximation of a JPEG image.

FIG. 8 shows a 4×4 array of low frequency coefficients of each eight by eight (8×8) block of decoded frequency coefficients. Reconstruction of the same yields an N/2×M/2 approximation of a JPEG image.

FIG. 9 shows all frequency coefficients of each eight by eight (8×8) block of decoded frequency coefficients. Reconstruction of the same yields an N×M approximation of a JPEG image.

FIG. 10 shows a default region of interest (ROI) in an image which has been partitioned in to an array of blocks.

FIG. 11 shows a decode and display of an approximation of a JPEG image using an upscaling operation.

FIG. 12 shows the factor of 2 parsing and storing of frequency coefficients.

FIG. 13 depicts a reconstruction of a complete JPEG image.

FIG. 14 depicts a reconstructed JPEG image of low frequency coefficients present in a top-left four by four (4×4) block of each eight by eight (8×8) block of decoded frequency coefficients.

FIG. 15 depicts a reconstructed JPEG image, which is obtained by reconstruction of four (4) Most Significant Bit/Bits (MSB) of all frequency coefficients.

FIG. 16 depicts a reconstructed JPEG image, which is obtained by reconstruction of five (5) MSB bits of all frequency coefficients.

FIG. 17 depicts a reconstructed JPEG image, which is obtained by reconstruction of six (6) MSB bits of all frequency coefficients.

FIG. 18 depicts a reconstructed JPEG image, which is obtained by reconstruction of five (5) MSB bits of low frequency coefficients present in the top-left four by four (4×4) block of each eight by eight (8×8) block of decoded frequency coefficients.

FIG. 19 depicts a reconstructed JPEG image of six (6) MSB bits of low frequency coefficients present in the top-left four by four (4×4) block of each eight by eight (8×8) block of decoded frequency coefficients.

FIG. 20 depicts a reconstructed JPEG image in a specific image quality, in this case, the chosen region of interest is a default region of interest.

FIG. 21 depicts a reconstructed JPEG image using a region specific for image quality, where JPEG image has been partitioned into an 8×8 array of blocks.

FIG. 22 further exemplifies the region of interest of FIG. 21.

FIG. 23 shows the Output Buffer which stores N/2×M/2 approximate reconstruction of a JPEG image and DCT coefficients.

FIG. 24 shows a User guided ROI which is of a Geometrical shape. ROI gets drawn in a geometrical shape as chosen by user.

FIG. 25 shows a User guided ROI which is drawn by user with a free hand. Data Units which are completely within the ROI are reconstructed with a relatively high quality.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

The following presents a simplified summary of one or more embodiments in order to provide a basic understanding of some aspects of such embodiments. This summary is not an extensive overview of the one or more embodiments, and is intended to neither identify key or critical elements of the embodiments nor delineate the scope of such embodiments. Its sole purpose is to present some concepts of the described embodiments in a simplified form as a prelude to the more detailed description that is presented later.

A progressively encoded JPEG bitstream contains AC frequency coefficients in multiple scans. An encoder could have partitioned frequency coefficients according to spectral selection and/or successive approximation as described in JPEG standard.

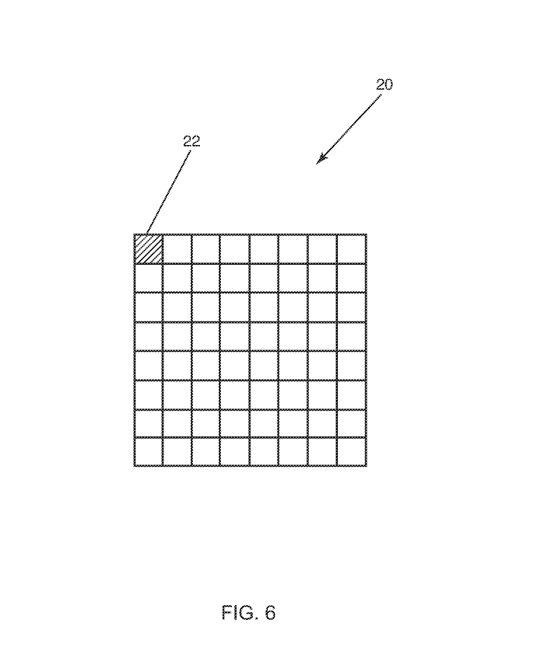

The preferred embodiment progressively decodes sub-sampled approximations of a JPEG Image. Resolution of these reconstructed sub-sampled approximations is typically smaller than the output resolution by a factor which is a power of 2, i.e., 2ⁿ. FIG. 6 illustrates which frequency coefficients of an 8×8 block are used for reconstructing sub-sampled approximations of a JPEG image. FIG. 6 shows that to reconstruct an N/8×M/8 approximation of a JPEG image only a DC coefficient of each 8×8 block, i.e. data unit, is used.

The JPEG Standard, Information Technology—Digital Compression and Coding of Continuous-Tone Still Images—Requirements and Guidelines”, T.81, September, 1992, does not specify the implementation of a two dimensional (2D) inverse discrete cosine transform (IDCT). A 2D IDCT can be implemented by a separable or a non-separable IDCT. The IDCT Kernel size is 1×1 if an N/8×M/8 approximation of a JPEG image is reconstructed. An IDCT Kernel size is 2×2 if an N/4×M/4 approximation of a JPEG image is reconstructed. An IDCT Kernel size is 4×4 if an N/2×M/2 approximation of a JPEG image is reconstructed. An IDCT Kernel size is 8×8 if a JPEG image of an N×M size is to be reconstructed. Therefore, sub-sampled approximations of a JPEG Image are reconstructed efficiently as they use the selected IDCT kernel size which is typically smaller than the normal IDCT kernel size by a factor, which is a power of 2, i.e., 2ⁿ.

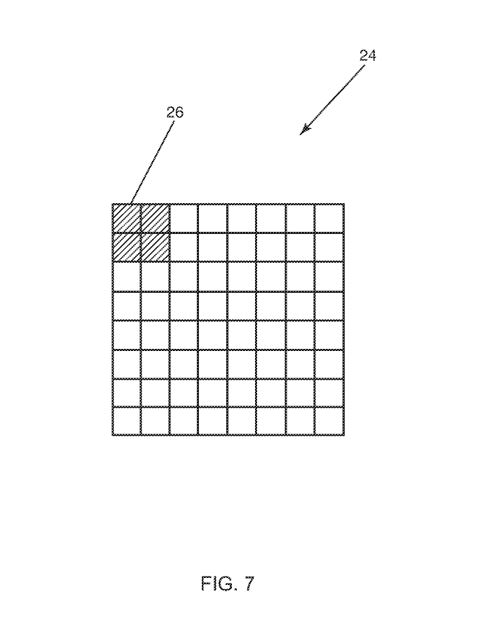

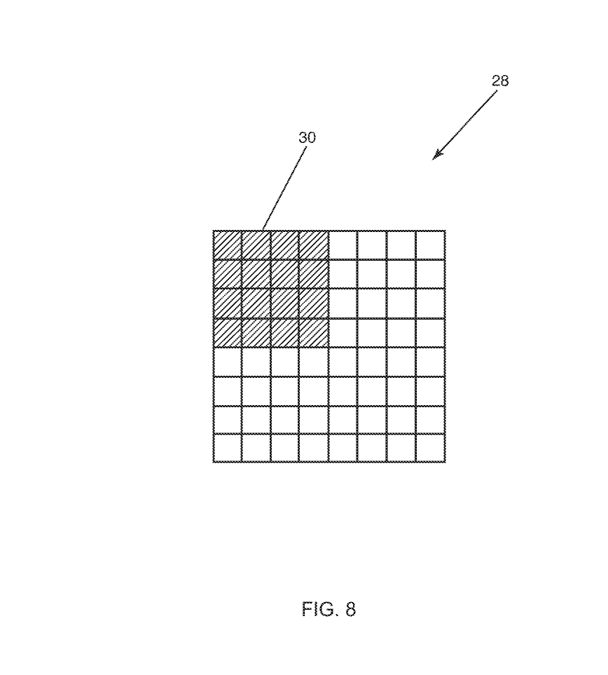

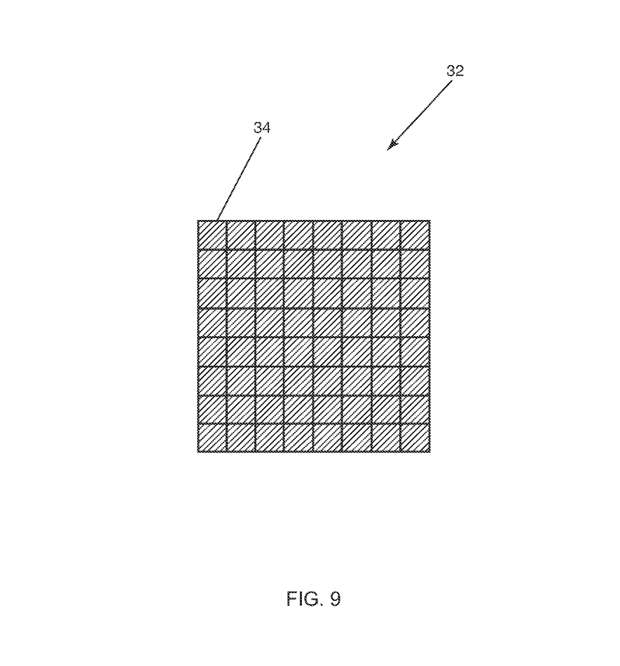

FIG. 6 shows a DC coefficient 22, extracted from an 8×8 transformed data unit 20, whose reconstruction using a reduced size, i.e. 1×1, IDCT kernel, results in an N/8×M/8 approximation of a JPEG image. After performing IDCT with an IDCT kernel of reduced size, a normalization step is required as IDCT kernel of reduced size is applied on DCT coefficients 20 which were obtained by using an 8×8 discrete cosine transform (DCT). FIG. 7 shows a 2×2 array of low frequency coefficients 26, extracted from an 8×8 transformed data unit 24, whose reconstruction using a reduced size, i.e. 2×2, IDCT kernel, results in a N/4×M/4 approximation of a JPEG image. FIG. 8 shows a 4×4 array of low frequency coefficients 30, extracted from an 8×8 transformed data unit 28, whose reconstruction using a reduced size, i.e. 4×4, IDCT kernel, results in a N/2×M/2 approximation of a JPEG image. FIG. 9 shows all frequency coefficients 34, extracted from an 8×8 transformed data unit 32, whose reconstruction using a corresponding size IDCT kernel results in a N×M JPEG image.

Decoding of a streaming progressive JPEG bitstream requires multiple decode cycles because all of the streaming progressive JPEG bitstream may not be available. Depending on the available bandwidth, the bitstream may arrive at different rate. Therefore, an approximation of the JPEG image is decoded from the available portion of progressive JPEG bitstream. As more and more portions of JPEG bitstream are received, they are decoded in conjunction with previous received portions of bitstream and sent for display, hence updating the previous approximations of JPEG image. This results in a gradual build-up of a JPEG image.

The preferred embodiments exploit the fact that the approximations of a JPEG image are intermediate display images which are of less relative importance as compared to a final JPEG image. The JPEG standard does not specify how or how many such approximations of a JPEG image should be reconstructed.

Each reconstruction requires an invocation of IDCT module, therefore multiple approximations require multiple invocations of the IDCT module.

The disclosed embodiments perform a faster IDCT by performing the IDCT simultaneously on more than one row and column of inverse quantized frequency coefficients. By using the disclosed embodiments, they reduce the dynamic range of frequency coefficients. The five least significant bits of frequency coefficients contribution on a reconstructed visual quality is minimal. Thus, they are dropped during IDCT operation for reconstruction of approximations of a JPEG image. A fixed point IDCT kernel is modified to be multiples of 4. Therefore, the dynamic range of a fixed point IDCT kernel can be reduced to 1/16^{th} of the original range.

The dynamic range reductions of frequency coefficients are shown by:

x1=2D_IDCT(X1)

x1=x1*32

where X=Frequency coefficient and X1=X/32.
Multiplication by 32 can be rolled into the normalization step generally performed as part of IDCT at the end of IDCT operation.

The dynamic range reduction of an IDCT kernel is shown as:

Original factors to be used for 4×4 IDCT

```
  #define W2 (2676/4) // 2048*sqrt(2)*cos(pi/8)
  #define W6 (1108/4) // 2048*sqrt(2)*cos(3*pi/8)
or
  #define W2 (669)  // 2048*sqrt(2)*cos(pi/8) /4
  #define W6 (277) // 2048*sqrt(2)*cos(3*pi/8) /4
```

Original factors can be represented to a sufficient accuracy by multiplication with 2048, i.e., 2¹¹. Resulting factors are a multiple of 4, thus the accuracy is maintained if the dynamic range of these factors is reduced by ¼^{th}.

The factors used for inverse transformation kernel as claimed in the preferred embodiments:

```
  #define W2 (669/4) // 2048*sqrt(2)*cos(pi/8)/16
  #define W6 (277/4) // 2048*sqrt(2)*cos(3*pi/8)/16
or
  #define W2 (167) // 2048*sqrt(2)*cos(pi/8) /16
  #define W6 (69) // 2048*sqrt(2)*cos(3*pi/8) /16
```

The dynamic range of intermediate computations during IDCT can be reduced to ½^{9th} of the original range. The intermediate dynamic range of AC coefficients=(2⁷−1)*(2⁷). This allows all IDCT computations to be done within 16 bit and allows Single Instruction Multiple Data (SIMD) implementation/16 bit arithmetic, i.e., efficient usage of a 16 bit instruction set supported by the processor such as ARM11 (a particular ARM chip where ARM stands for Advanced RISC Machines) and the like.

This efficient implementation easily allows IDCT computation reduction by a factor greater than 50%.

Another embodiment discloses an efficient IDCT implementation for a JPEG bitstream encoded using successive approximations. AC frequency coefficients for 8 bpp have a dynamic range of 0 to 2¹¹. Reconstruction of just 4 to 6 most significant bits of frequency coefficients of a JPEG bitstream encoded using successive approximations gives decent image quality for the reconstruction of approximations of a JPEG image. This is shown as:

x1=2D_IDCT(X1)

x1=x1*64

wherein X=Frequency coefficient and X1=X/64.

Multiplication by 64 can be rolled into the normalization step generally performed as part of IDCT at the end of an IDCT operation.

The dynamic range of intermediate computations during IDCT can be reduced to ½¹⁰ of the original range. The intermediate dynamic range of AC coefficients=(2⁶−1)*(2⁷). This allows all IDCT computations to be done within 16 bit, hence allowing a SIMD implementation 16 bit arithmetic, i.e., efficient usage of 16 bit instruction set supported by the processor such as ARM 11 and the like.

The disclosed embodiments also support region of interest decoding. All regions of a JPEG image may not be of immediate and simultaneous importance to a user. The embodiments reconstruct certain regions of a JPEG image with a lower quality as compared to other regions in which relatively higher quality is maintained.

Region of interest decoding of image quality is particularly useful for reconstructing approximations of a JPEG image. It enables efficient reconstruction of JPEG image using less computational resources. This type of decoding can be used where a user is interested in only portions of a JPEG image, thus, it is a waste of computational resources to decode unwanted regions. Secondly, display resolution of a display device may be much less than that of the resolution of JPEG image. In this case, a user has to either downscale the reconstructed image or crop the reconstructed image. Again, it is a waste of computational resources to decode unwanted regions and then either downscale or crop away the same. Finally, region of interest decoding of image quality can be used to decode and display approximations of a JPEG image.

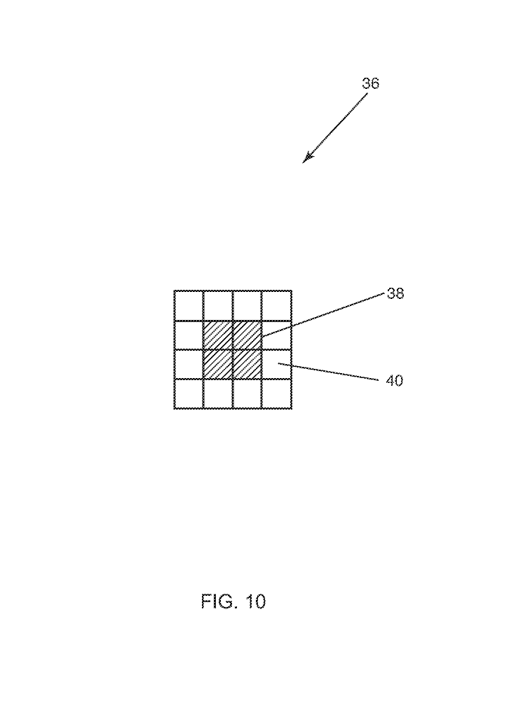

A default region of interest is also disclosed. Objects of interest are generally centered in an image 36, as shown in FIG. 10. A user can choose to divide the image into a 4×4 array. Outer regions 40 are reconstructed with a low Image quality. Inner regions 38 are reconstructed with a relatively higher image quality. Reconstruction of the low quality regions 40 can be done using less computational resources as compared to the high quality regions 38.

The low image quality is obtained by providing the IDCT kernel size to be half in height and/or width to that of an IDCT kernel size in a high quality region. The dynamic range of frequency coefficients in low quality region can be less as compared to the dynamic range of frequency coefficients in a high quality region.

Instead of using the default region of interest, a user can input user guided regions of interest to a JPEG decoder via “Mouse”, “Keyboard” or “touch screen”. The regions of interest are reconstructed with higher image quality.

An output buffer can be used as an intermediate buffer in the disclosed embodiments. Most STB and DTV uses require a progressive JPEG bitstream to be decoded in 2 ways: decoding a JPEG file in a single pass; and decoding a progressive JPEG bitstream, which is being streamed over a network.

Decoding of a progressive JPEG image requires an intermediate buffer of certain size that could be as much as bytes per DCT coefficient×N×M×number of color components. In comparison, the disclosed embodiments use an intermediate buffer of reduced size and temporarily use an output buffer as an intermediate buffer to store DCT coefficients.

The embodiments herein disclose the reconstruction of sub-sampled approximations of a JPEG image. An output buffer size can vary from “pixel depth in bytes×N×M×number of color components” to “pixel depth in bytes×(N×M+N×M×(number of color components−1)×¼)” depending on the output color format. The output color formats can be YUV 4:4:4, YUV 4:2:2, YUV 4:2:0, CMYK, etc. The YUV 4:4:4, YUV 4:2:2, YUV 4:2:0 are normally used by digital cameras and the content present on the internet is largely in these color formats. Pixel depth in bytes can be 1 byte or 2 bytes depending on whether input sample precision is 8 bits per pixel (bpp) bits or 12 bpp.

Sub-sampled reconstructed approximations of a JPEG image require an intermediate buffer which is at most ¼^{th} the size of the output buffer. The intermediate buffer required for storing frequency coefficients for decoding sub-sampled approximations of a JPEG image varies from “intermediate sample bit depth in bytes×N×M×number of color components×¼)” to “¼×intermediate sample bit depth in bytes×(N×M+N×M×(number of color components−1)×¼)” which is clearly less than the total output buffer memory available.

“Intermediate sample bit depth in bytes” can be 1 byte or 2 bytes depending on the dynamic range of the entropy decoded DCT coefficient.

In the worst case only ¾ (¼ for storing the sub sampled reconstruction and ½ for storing the corresponding DCT coefficients) of the output buffer will be used for simultaneously storing the frequency coefficients and reconstructed outputs. The worst case is defined as each frequency coefficient of each color component requiring 16 bits for storage and each reconstructed sample of each color component requiring 8 bits for storage. Sub-Sampled approximations of a JPEG image can be reconstructed and sent to display without overwriting the decoded frequency coefficients while ¼^{th} of the output buffer memory is still available for decoding the progressive JPEG bitstream being received.

After sub-sampled approximations of a JPEG image have been reconstructed and sent to the display, the next step is to reconstruct the final JPEG image to be sent to the display.

The final JPEG image is decoded efficiently and displayed, and the final image is not required until the complete image has been decoded.

For reconstruction of a final JPEG image a small buffer along with an output buffer can be used to temporarily store the DCT coefficients of an image component.

Following is the sequence of operations which are performed for decoding a progressively encoded JPEG file.
At one time only one image component is decoded.
Depending on the color format and other attributes of a JPEG bitstream, a decoding order of image components that requires a minimal amount of intermediate memory.
Decoding of next image component is started only after the decoding of a current image component is finished.
Entropy decode all scans of an image component. A small buffer along with output buffer is normally big enough to store all the required DCT coefficients of one image component even if most of the frequency coefficients require 16 bits.
Store the quantized frequency coefficients, i.e. DCT coefficients, in the output buffer. Almost all quantized DCT coefficients of an 8 bit sample precision can be stored in 8 bits due to the quantization. If some frequency coefficients require 16 bits, then the frequency coefficients can be known by an input sample precision and/or a quantization table used for a particular component.
As an alternative to above step, if enough memory is available to store each DCT coefficient in 16 bits then the inverse quantized frequency coefficients are stored. This helps in reducing the repetitions of inverse quantization operations which otherwise would have to be done if the quantized DCT coefficients are stored.
Defer performing rest of the decoding processes such as inverse quantization, IDCT, color format conversion, and the like until the quantized DCT coefficients from all scans of a particular image component become available.
Decode each MCU/data unit and store the decoded MCU in the output buffer.

In this section, the worst case memory required by the claimed embodiments as an intermediate buffer for decoding a progressively encoded JPEG image is discussed. The worst case is defined for an 8 bpp input sample precision.

Memory available in an output buffer for storing frequency coefficients for a YUV 420 color format, is defined below. Following is the total amount of memory available for storing DCT coefficients.

Y Component Output Buffer

W×H bytes of memory is available as a Y component output buffer. W×H/4 is used for storing the sub-sampled Y output. Therefore, ¾×W×H of the Y component output buffer will be available for storing the frequency coefficients.

Cb Component Output Buffer

W×H/4 bytes of memory is available as the Cb component output buffer. W×H/4×¼ is used for storing the sub sampled Cb output. Therefore, ¾×W×H/4 of the Cb component output buffer will be available for storing the Frequency coefficients.

Cr Component Output Buffer

W×H/4 bytes of memory is available as the Cr component output buffer. W×H//4 ¼ is used for storing the sub sampled Cr output. Therefore, ¾×W×H/4 of the Cr component output buffer will be available for storing the Frequency coefficients.

An all component decode and display comprises a Y component Output Buffer Memory available for storing frequency coefficient=¾×W×H.

The Cb component output buffer memory available for storing frequency coefficient=¾×W×H/4. The Cr component output buffer memory available for storing frequency coefficient=¾×W×H/4

Memory Used for Storing Frequency Coefficients of a Subsampled JPEG

The Y component output buffer memory used=½×W×H.

The Cb component output buffer memory used=½×W×H/4.

The Cr component output buffer memory used=½×W×H/4.

Memory Available for Decoding a Complete JPEG Image

The Y component output buffer memory available=¼×W×H.

The Cb component output buffer memory available=¼×W×H/4.

The Cr component output buffer memory available=¼×W×H/4.

Extra Memory Needed for Decoding Complete JPEG Image

More memory than is available is normally required. The extra memory which is required is calculated as:

The extra memory for the Y component=total required memory−available memory=2×W×H−(½×W×H+¼×W×H+¼×W×H/4+¼×W×H/4)=2×W×H−(⅞×W×H)=9/8×W×H.

The extra memory for the Cb/Cr component=total required memory−available memory=W×H/2−(½×W×H/4+¼×W×H/4+¼×W×H/4)=W×H/2−(W×H/4)=W×H/4.

The extra memory for the Cr/Cb component=total required memory−available memory=W×H/2−(½×W×H/4+¼×W×H/4)=W×H/2−(¾×W×H/4)= 5/16×W×H.

Since one component at a time is being decoded, only the highest extra memory per component is needed. In this case the Y component has the highest extra memory. Therefore, for YUV 420 an extra memory of 9/8×W×H is sufficient.

To progressively decode one component, a Y component, the memory requirement can be minimized if only if the luminance component is reconstructed progressively and chrominance components are reconstructed during the complete decoded of a JPEG image.

The Y component is the output buffer memory available for storing frequency coefficient=¾×W×H.

The Cb component is the output buffer memory available for storing the frequency coefficient=W×H/4.

The Cr component is the output buffer memory available for storing frequency coefficient=W×H/4.

Memory Used for Storing Frequency Coefficients of Subsampled Y Component of JPEG

The Y component is the output buffer memory used=½×W×H.

The Cb component is the output buffer memory used=none.

The Cr component is the output buffer memory used=none.

Memory Available for Decoding Complete JPEG Image

The Y component is the output buffer memory available=¼×W×H.

The Cb component is the output buffer memory available=W×H/4.

The Cr component is the output buffer memory available=W×H/4.

Extra Memory Needed for Decoding Complete JPEG Image

There is more memory needed than is available. The extra memory required is calculated as:

extra memory for Y component=total required memory−available memory=2×W×H−(½×W×H+¼×W×H+W×H/4+W×H/4)=2×W×H−(5/4×W×H)=¾×W×H

The extra memory for the Cb/Cr component=total required memory−available memory=W×H/2−(W×H/4+W×H/4)=W×H/2−(W×H/2)=0.

The extra memory for the Cr/Cb component=total required memory−available memory=W×H/2−(W×H/4)=W×H/4.

Since one component at a time is being decoded, only the highest extra memory per component is needed. In this case the Y component has the highest extra memory.

Therefore, for YUV 420 an extra memory of ¾×W×H is sufficient.

The memory available in an output buffer for storing frequency coefficients for a YUV color format is disclosed. The following is the total amount of memory available for storing DCT coefficients.

Y Component Output Buffer

W×H bytes of memory is available as the Y component output buffer. W×H/4 is used for storing the sub sampled Y output. Therefore, ¾×W×H of the Y component output buffer is available for storing the frequency coefficients.

Cb Component Output Buffer

W×H bytes of memory is available as the Cb component output buffer. W×H/4 is used for storing the sub sampled Cb output. Therefore, ¾×W×H of the Cb component output buffer is available for storing the frequency coefficients.

Cr Component Output Buffer

W×H bytes of memory is available as the Cr component output buffer. W×H/4 is used for storing the sub sampled Cr output. Therefore, ¾×W×H of the Cr component output buffer is available for storing the frequency coefficients.

For an all component decodes and displays, the Y component output buffer memory available for storing the frequency coefficient=¾×W×H. The Cb component output buffer memory available for storing the frequency coefficient=¾×W×H. The Cr component output buffer memory available for storing the frequency coefficient=¾×W×H.

Memory Used for Storing Frequency Coefficients of Subsampled JPEG

The Y component output buffer memory used=½×W×H.

The Cb component output buffer memory used=½×W×H.

The Cr component output buffer memory used=½×W×H.

Memory Available for Decoding Complete JPEG Image

The Y component output buffer memory available=¼×W×H.

The Cb component output buffer memory available=¼×W×H.

The Cr component output buffer memory available=¼×W×H.

Extra Memory Needed for Decoding Complete JPEG Image

More memory than is available is needed. The extra memory which is required is calculated as:

extra memory for Y component=total required memory−available memory=2×W×H−(½×W×H+¼×W×H+¼×W×H+¼×W×H)=2×W×H−(5/4×W×H)=¾×W×H.

The extra memory for the Cb/Cr component=total required memory−available memory=2×W×H−(½×W×H+¼×W×H+¼×W×H)=W×H.

The extra memory for the Cr/Cb component=total required memory−available memory=2×W×H−(½×W×H+¼×W×H)=5/4×W×H.

Since one component at a time is being decoded, only the highest extra memory per component is needed. In this case component which is decoded last has the highest extra memory. Therefore, for YUV 420 an extra memory of 5/4×W×H is sufficient.

For a progressive decode of one component, a Y component, the memory requirement can be minimized if only the luminance component is reconstructed progressively and the chrominance components are reconstructed during the complete decoded of a JPEG image.

The Y component output buffer memory available for storing a frequency coefficient=¾×W×H. The Cb component output buffer memory available for storing a frequency coefficient=W×H. The Cr component output buffer memory available for storing a frequency coefficient=W×H.

Memory Used for Storing Frequency Coefficients of Subsampled Y Component of JPEG

The Y component output buffer memory used=½×W×H.

The Cb component output buffer memory used=none

The Cr component output buffer memory used=None

Memory Available for Decoding Complete JPEG Image

The Y component output buffer memory available=¼×W×H.

The Cb component output buffer memory available=W×H.

The Cr component output buffer memory available=W×H.

Extra Memory Needed for Decoding Complete JPEG Image

More memory than is available is needed. The extra memory required is calculated as:

extra memory for Y component=total required memory−available memory=2×W×H−(½×W×H+¼×W×H+W×H+W×H)=−¾W×H.

The extra memory for the Cb/Cr component=total required memory−available memory=2×W×H−(W×H+W×H)=0.

The extra memory for the Cr/Cb component=total required memory−available memory=2×W×H−(W×H)=W×H.

Since one component at a time is being decoded, only the highest extra memory per component is needed. In this case Y component has the highest extra memory. Therefore, for YUV 420 an extra memory of W×H is sufficient.

Overall if 5/4×W×H size of an intermediate buffer is used for a progressive JPEG decode then it is possible to decode picture of any size, input sample precision and color format.

A decoding order of image components affects the amount of memory required for decoding a progressive JPEG image. The memory requirement for decoding a YCbCr 4:2:0 JPEG image can be different depending on which component is chosen first for decoding.

Previously discussed is the intermediate memory required to store DCT coefficients during a decoding operation which depends on the color format. The amount of memory used for a progressive JPEG decode, besides the color format depends on other factors such as a quantization matrix used for each component, last non-zero scan of an image component and on runs of zeros.

The claimed embodiments analyze the image and scan headers of the JPEG image to obtain the information on number of bytes required for storing each MCU/Data Unit and number of zero coefficients in each component. This information along with the color format is used for deciding an optimal decode order of a JPEG image.

For a YCbCr 4:2:0 and YCbCr 4:2:2 color format the optimal decoding order is Y, Cb/Cr and Cr/Cb. This decoding order can change on run time depending on the quantization matrix used for each component, last non-zero scan of an image component and on runs of zeros.

For a YCbCr 4:4:4 color format, the optimal decoding order can be any but is preferably chosen to be Y, Cb and Cr. This decoding order can change on run time depending on the quantization matrix used for each component, last non-zero scan of an image component and on runs of zeros.

Instead of using a IDCT computation to upscale approximations of a JPEG image, the preferred embodiment uses software/hardware up-scaling operation. Such a division of work flow is efficient when a core operation inherently performs an up-scaling operation in addition to data processing operation such as decoding. The up-scaling operation is performed by a separate module, thus, the JPEG decoder requires less computation to decode a progressive JPEG image leading to a faster progressive JPEG decode in real time.

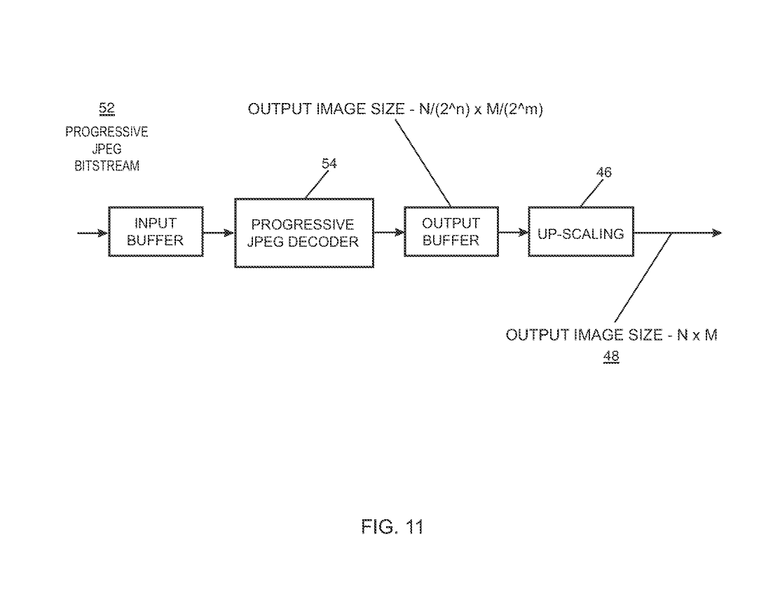

FIG. 11 shows how the Sub-sampled approximations of a JPEG image are upscaled by using a software/hardware up-scaling operation 46. Progressive JPEG decoder 54 reconstructs a sub-sampled approximation of a progressive JPEG image by reconstructing 8/2ⁿ×8/2^{m} frequency coefficients of an eight by eight (8×8) entropy decoded frequency coefficients of a data unit block. An 8×8 is the size of data unit and minimum value of 8/2ⁿ or 8/2^{m} is 1, so at least 1 frequency coefficient of an eight by eight (8×8) entropy decoded frequency coefficients of a data unit block is reconstructed. Progressive JPEG Decoder writes the reconstructed sub-sampled approximation of a progressive JPEG image into the Output Buffer. Up-scalar 46 upscales the output image from N/2ⁿ×M/2^{m} to N×M. A software up-scaling operation if used, preferably runs on a separate processor. Optionally image enhancement operations can be used prior to up scaling or after scaling. Such image enhancements operations can be de-ringing, de-blocking, color correction, white balance etc.

The preferred embodiments decode one image component in its entirety before it progresses to decode other image components. The JPEG standard mandates that all AC DCT coefficients of an image component for a progressive JPEG image be encoded in a non-interleaved mode, i.e., AC DCT coefficients of each image component shall be present as a separate scan in a JPEG bitstream. For example, N image components are present in a progressively encoded JPEG bitstream. An embodiment chooses to decode all DCT coefficients of one image component before it progresses to decode DCT coefficient of next image component. The strategy of decoding one image component at a time reduces the intermediate memory required to decode a progressively coded JPEG bitstream by a factor of N, only frequency coefficients, i.e., DCT coefficients of one component has to be stored. The progressive mode of JPEG allows only DC coefficients of all image components to be encoded in an interleaved mode. The storage of DC coefficients of other image components require typically (N−1)×W×H× 2/64 bytes of memory. The number of image components in an image are usually in a single digit. Since only one image component is decoded before proceeding to the next image component, the memory required to store the DCT coefficients is proportional to the number of DCT coefficients present in one image component. Thus, the total intermediate memory requirement is (N−1)×W×H× 2/64+W×H×2.

If the preferred embodiment is decoding a JPEG bitstream contained in a file then all scans of an image component are entropy decoded and are scheduled for the rest of decoding processes, i.e., decoding processes which are performed after entropy decoding, once all quantized frequency/DCT coefficients of an image component become available. This helps in reducing the computation resources (IDCT, memory bandwidth, data copy, color format conversion, etc.) required to decode and display an image.

The preferred embodiment decodes a streaming progressive JPEG bitstream, which is being delivered over the internet.

Sub-sampled approximations of a JPEG image are decoded, reconstructed and sent for display. Sub-sampled approximations of JPEG image are decoded in a component wise manner, i.e., at the time a single component is decoded, an approximation of the next component is scheduled for decoding only after approximation of the previous component has been decoded. Once approximations of all image components become available, they are sent for display as an all component approximation of a JPEG image. After N/2×M/2 approximation of a JPEG image has been decoded and displayed, entire N×M JPEG image is decoded and displayed next. The decode of a complete JPEG image is again performed in a component wise manner. An image component is scheduled for decoding in its entirety. Decoding of next image component is not started unless the previous image component has been decoded in its entirety. An image component is scheduled for the rest of the decoding processes once all DCT coefficients of a MCU/Data Unit of this image component becomes available. This process is repeated for the rest of the image components unless all image components are reconstructed. An updated image can be chosen for display when a next image component becomes available for display, i.e., all image components are displayed in succession, i.e. one after the other, or a display of all image components can be chosen at one go. As a result user may experience a gradual build-up of an all component JPEG image, i.e., display of coarse approximation of an image followed by display of a final image.

For a single component sub-sampled progressive JPEG Decode, DC coefficients of all image components are reconstructed and image reconstructed using DC coefficients is sent to the display. Luminance scans (if image was coded in YCbCr color format) are then scheduled for decoding and display. Sub-sampled approximations of the luminance component of the JPEG image are then decoded, reconstructed and sent for display. Once all luminance scans have been decoded, i.e., complete reconstruction of a luminance component, another image component is scheduled for the rest of decoding processes once all DCT coefficients of a MCU/Data Unit of this image component become available. This process is repeated for the rest of the image components unless all image components are reconstructed. An updated image can be displayed when the next image component becomes available for display, i.e., all image components are displayed in succession one after the other, or all the image components are displayed at one time with the already displayed luminance component. As a result user may experience a gradual build of one component, i.e., luminance component, as an approximation of a JPEG image followed by component by component build-up of a JPEG image.

For a decode of a successive approximation encoded progressive JPEG bitstream, most significant bits of the frequency coefficients are decoded in a component wise manner, i.e., at a time single component is decoded and approximation of the next component is scheduled for decoding only after an approximation of previous component has been decoded. Once approximations of all image components become available, they are sent for display as an all component approximation of a JPEG image. After 4 to 5 MSB's of the frequency coefficients have been decoded and displayed for 8 bpp image, all the bits of frequency coefficients of complete N×M JPEG image are decoded and displayed. A decode of the complete JPEG image is again performed in a component wise manner. An image component is scheduled for decoding in its entirety. Decoding of the next image component is not started unless this image component has been decoded in its entirety. An image component is scheduled for the rest of the decoding process once all bits of all DCT coefficients of a MCU/data unit of the image component become available. This process is repeated for the rest of the image components unless all image components are reconstructed. An updated image can be displayed as and when the next image component becomes available for display, i.e., all image components are displayed in succession one after the other, or all image components can be displayed at one go. As a result, user may experience a gradual build-up of all component JPEG images, i.e., display of coarse approximation of an image followed by display of a final image.

For storing a subset of frequency coefficients, a JPEG frame header specifies the horizontal and vertical sampling factor for each image component. An output size of an image can be smaller as compared to an input size. The output color format may also cause some of the image components to be downsampled. Factors of two (2) are collected by factoring:
The horizontal and vertical down-sampling factor;
A ratio to input rows and columns to output rows and columns; and
A ratio to one image component to another image component if this ratio is not already factored into a frame header for each component according to the output color format.

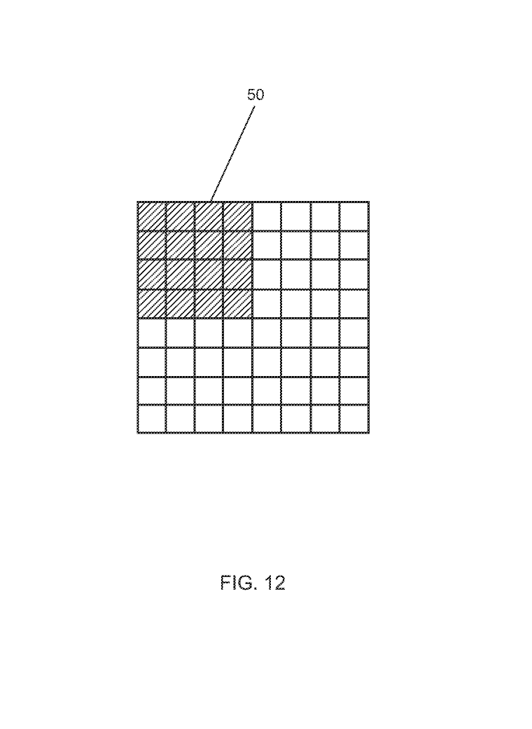

Factors of two (2) collected for row and column are used to choose which frequency coefficients should be parsed and stored. Frequency coefficients that are not chosen are dropped, resulting in memory saving. FIG. 12 shows the factor of two (2) parsing and storing of frequency coefficients. If the overall down-sampling factor for both row and column is two (2) then only the frequency coefficients 50 of a frequency transformed data unit are parsed and stored.

If an image component has more than 1 non-zero scans which are scheduled for parsing then storage of the frequency coefficients of the last non-zero scan of image components which is to be parsed is skipped. When the last non-zero scan is being decoded, entropy decoded DCT coefficients of the last non-zero scan are stored directly in to MCU/Data Unit DCT coefficient buffer used for reconstructing the current MCU/Data Unit. When the last non-zero scan is being decoded, all required DCT coefficients of a MCU/Data Unit become available and this MCU/data unit is scheduled for rest of the decoding processes hence there is no need to store all the DCT coefficients of the last non-zero scan, resulting in memory savings and reducing data copy to and from memory.

In a spectral selection progressive mode, frequency coefficients may not be stored. However, in case of successive approximation partial bits of frequency coefficients may not be stored resulting in reducing the dynamic range required to store DCT coefficients. In a successive approximation cases, dynamic range reduction by skipping storage of last non-zero scan of an image component is helpful if a quantization parameter is less than 16 for the DC coefficient and less than 8 for the AC coefficient. In successive approximations, a dynamic range reduction enables memory reduction because 8 bits can be used instead of 16 bits to store quantized frequency coefficients, if the image sample precision is more than 8 bits. If image sample precision is 12 bits, this will cause the DC coefficients to have a 16 bit dynamic range and AC coefficients to have 15 bit dynamic range. In this case, the quantization and avoidance of storage of bits of the last non-zero scan can help in reducing the 16 and 15 bit dynamic range of DC and AC coefficients to 8 bits.

The last non-zero scan to be skipped can be chosen in the following ways depending on whether the user wants to provide a progressive display experience or wants to use the minimal possible memory. Four parameters Ss, Se, Ah, and Al for the last non-zero scan indicates where to place and/or insert the frequency coefficients and their bits in the intermediate MCU/Data Unit size buffer which temporarily contains the DCT coefficients on which inverse quantization and inverse IDCT is performed.

In this method, minimization of the memory used to store the frequency coefficients of a particular image component results. The following information is obtained from all the scan headers of particular image component Ss, Se, Ah, and Al.

Ss is defined as the start of spectral or predictor selection. In the DCT modes of operation, this parameter specifies the first DCT coefficient in each block in zigzag order, which shall be coded in the scan.

Se is defined as an end of spectral selection. This specifies the last DCT coefficient in each block in zigzag order, which shall be coded in the scan. This parameter shall be set to 63 for the sequential DCT processes.

Ah is defined as successive approximation bit position high. This parameter specifies the point transform used in the preceding scan (i.e. successive approximation bit position low in the preceding scan) for the band of coefficients specified by Ss and Se. This parameter shall be set to zero for the first scan of each band of coefficients.

Al is defined as successive approximation bit position low or point transform. In the DCT modes of operation this parameter specifies the point transform, i.e., bit position low, used before coding the band of coefficients specified by Ss and Se.

A scan which contains the maximum frequency coefficients and/or bits of DCT coefficients is chosen. The chosen scan is scheduled to be entropy decoded as the last non-zero scan. Choosing a scan as the last non-zero scan which contains the maximum frequency coefficients and/or bits of DCT coefficients minimizes the memory required for storing: “total number scans per image component−1” scan.

Since approximations of JPEG image are being decoded in hierarchical resolutions, the decision of choosing the last non-zero scan will be biased towards the scan which contains the high frequency coefficients or the low order bits of DCT coefficients.

High frequency coefficients are generally required for fine improvements in image. Scans containing high frequency coefficients and/or low order bits of DCT coefficients are chosen to be the last non-zero scan.

There are various use cases that require set top box and DTV to support decoding of a progressively encoded JPEG image. Progressively encoded JPEG content is becoming available on internet because of disparity in the growth of bandwidth and available computation resources. Use cases are
Internet browsing on Set Top Box
Decode and Display of JPEG Images downloaded from internet/intranet, which may be wired or wireless or a combination thereof.
Decode and Display of JPEG Images shared via Storage devices such as USB stick, USB Hard disk, SATA Hard Disk, Flash, etc.
Decode and Display of JPEG Images shared over relative close distance wired/wireless channel such as Bluetooth, WI-FI etc.
Set Top Box and DTV are being connected to a Home Network, Set Top Box/DTV Network and internet.

Generally set top box solutions use a JPEG library for decoding a progressive JPEG bitstream. The JPEG library and some of the prior art use W×H×N×2 bytes or similar order of intermediate memory to store DCT coefficients. In comparison, the claimed embodiments reduce the memory requirement to approx. 9/8×W×H (YCbCr 4:2:0) or 5/4×W×H (all color formats) bytes of memory. W×H is typically 4 to 9 MB or more.

The disclosed embodiments reduce the intermediate memory required for decoding a progressively encoded JPEG bitstream by a considerable amount. It simultaneously reduces the computation resources required to decode a progressively encoded image (JPEG/JPEG-XR) bitstream. These embodiments increase the performance efficiency in terms of real time performance as well as reduce the power consumed for decoding a progressively encoded JPEG bitstream.

Usage of JPEG is widespread on the internet and is used on digital cameras, mobile phones, hand held devices, and other devices that use JPEG as an option to compress images. JPEG-XR is new still image coding standard that will compete with JPEG. JPEG-XR also has a mode which is similar to the progressive mode of JPEG.

The embodiments disclosed herein are of significant value to the multimedia entertainment industry and applicable to data archiving and the medical imaging industry. They are also of significant importance to the following products:
Handheld Devices
Video solutions on programmable DSP chipsets.
Home Networking

The disclosed embodiments are equally applicable to any image coding standard which uses the same philosophy as used by JPEG image coding standard for progressive coding.

While various embodiments of the disclosed method and apparatus have been described above, it should be understood that they have been presented by way of example only, and should not limit the claimed invention. Likewise, the various diagrams may depict an example architectural or other configuration for the disclosed method and apparatus. This is done to aid in understanding the features and functionality that can be included in the disclosed method and apparatus. The claimed invention is not restricted to the illustrated example architectures or configurations, rather the desired features can be implemented using a variety of alternative architectures and configurations. Indeed, it will be apparent to one of skill in the art how alternative functional, logical or physical partitioning and configurations can be implemented to implement the desired features of the disclosed method and apparatus. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

### INDUSTRIAL APPLICABILITY

The claimed invention is further illustrated by the following non-limiting examples.

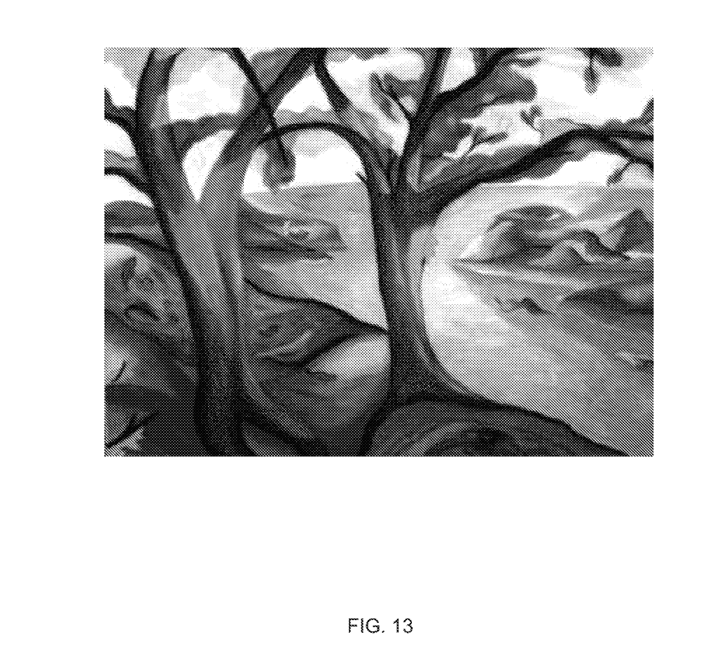

FIG. 13 depicts a reconstruction of a complete JPEG image.

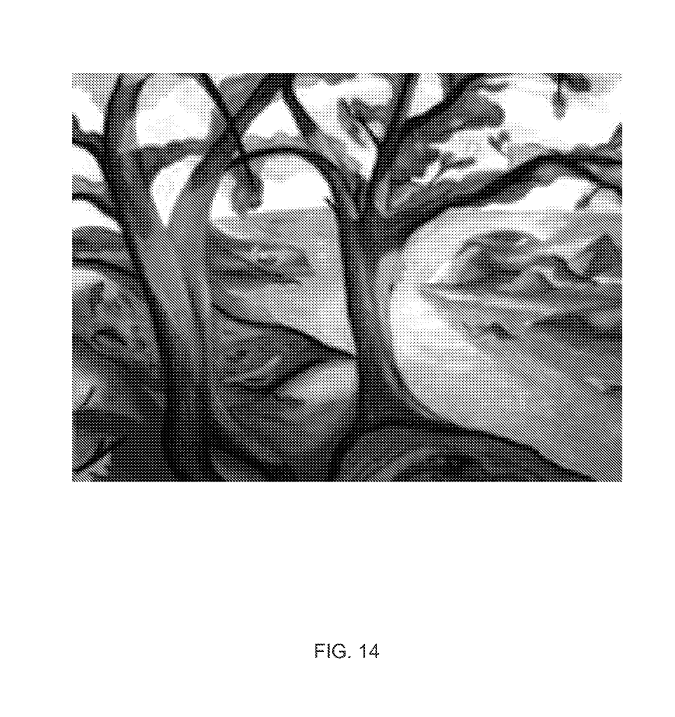

FIG. 14 depicts a reconstructed JPEG image of low frequency coefficients present in a top-left four by four (4×4) block of each eight by eight (8×8) block of decoded frequency coefficients.

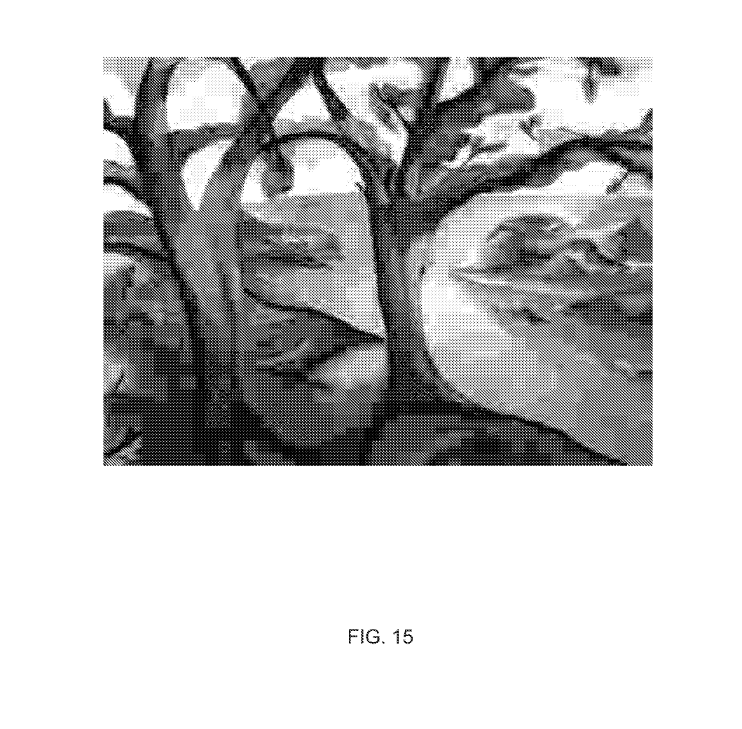

FIG. 15 depicts a reconstructed JPEG image, which is obtained by reconstruction of four (4) MSB bits of all frequency coefficients.

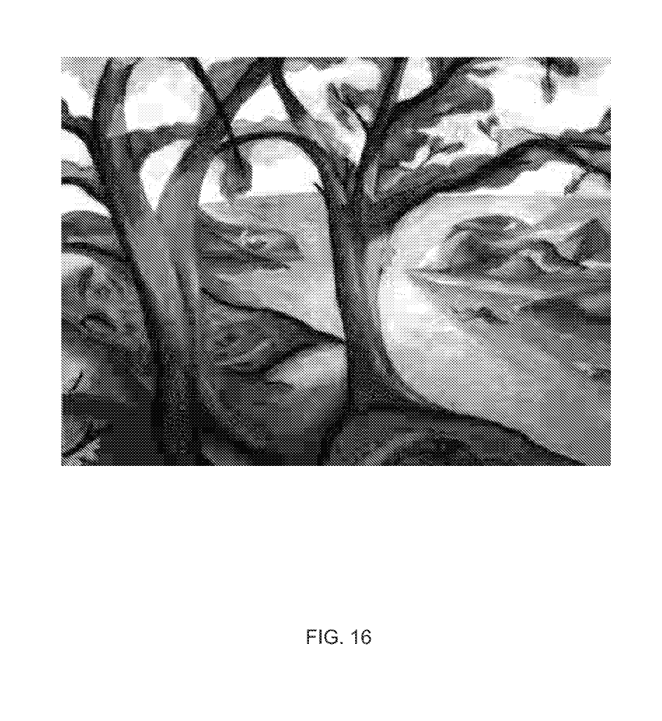

FIG. 16 depicts a reconstructed JPEG image, which is obtained by reconstruction of five (5) MSB bits of all frequency coefficients.

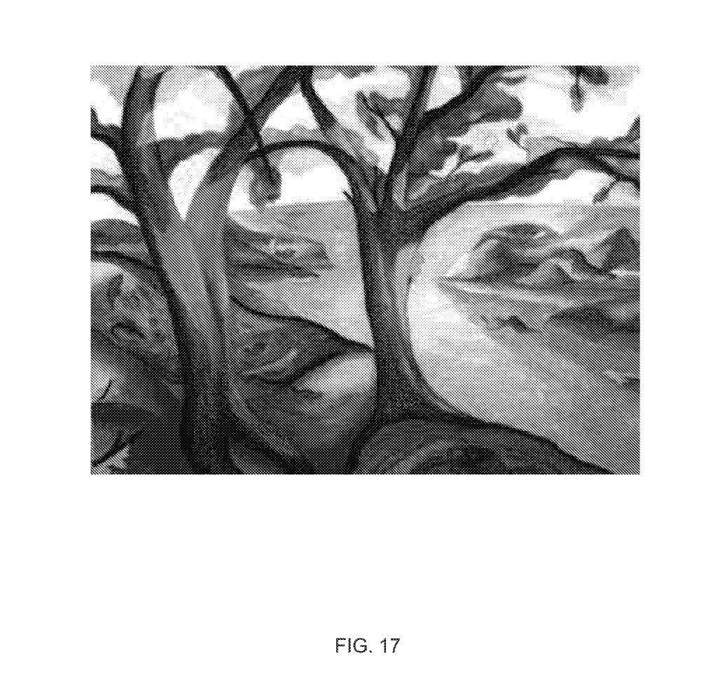

FIG. 17 depicts a reconstructed JPEG image, which is obtained by reconstruction of six (6) MSB bits of all frequency coefficients.

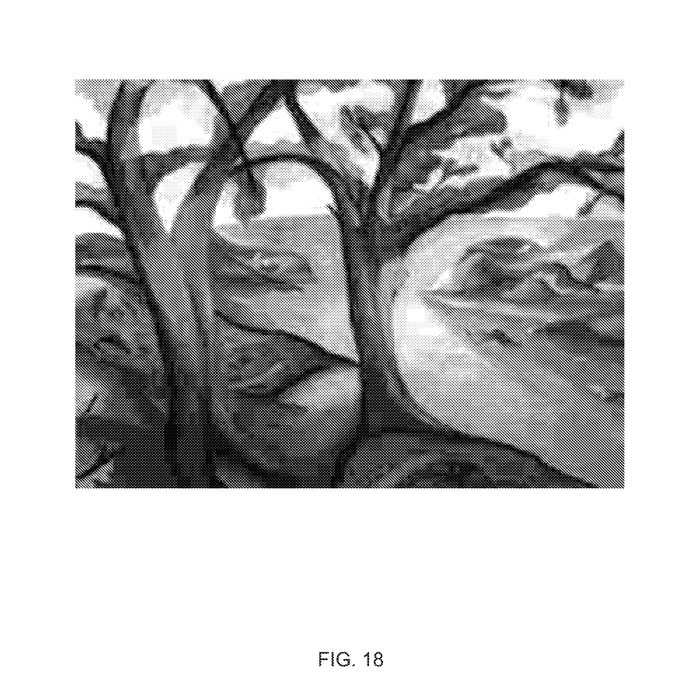

FIG. 18 depicts a reconstructed JPEG image, which is obtained by reconstruction of five (5) MSB bits of low frequency coefficients present in the top-left four by four (4×4) block of each eight by eight (8×8) block of decoded frequency coefficients.

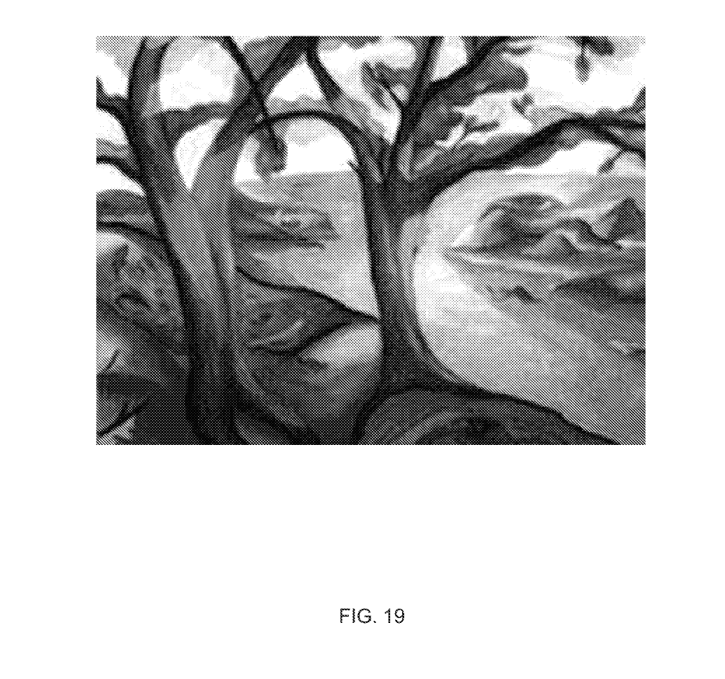

FIG. 19 depicts a reconstructed JPEG image of six (6) MSB bits of low frequency coefficients present in the top-left four by four (4×4) block of each eight by eight (8×8) block of decoded frequency coefficients.

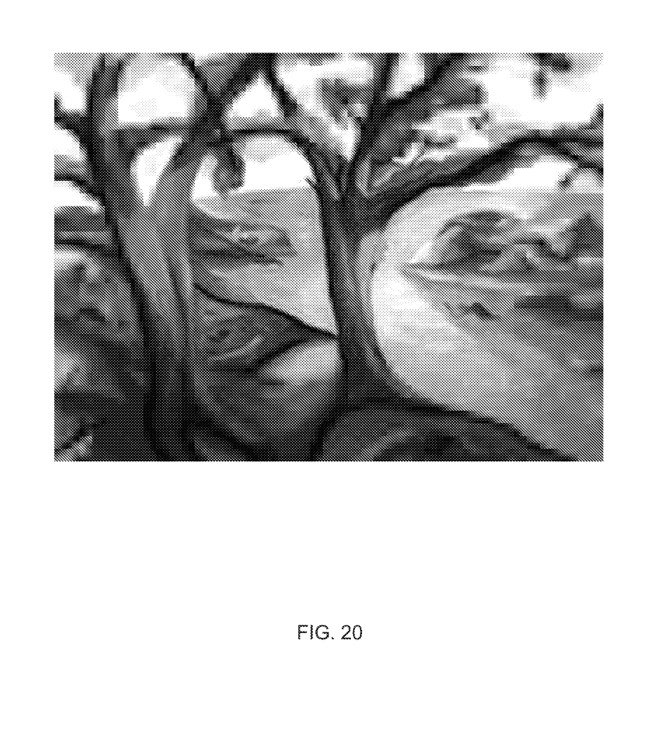

FIG. 20 depicts a reconstructed JPEG image in a specific image quality, in this case, the chosen region of interest is a default region of interest. The region of interest is further exemplified in FIG. 10.

FIG. 10 shows the region of interest 38 in an image which has been partitioned into a four by four (4×4) array of blocks. Regions 40 which are not of interest are not shaded. Non-shaded region 40 is reconstructed using a two by two (2×2) IDCT kernel on two by two (2×2) low frequency coefficients of each eight by eight (8×8) block of decoded frequency coefficients. Shaded region 38 is reconstructed using a four by four (4×4) IDCT kernel on four by four (4×4) low frequency coefficients of each eight by eight (8×8) block of decoded frequency coefficients.

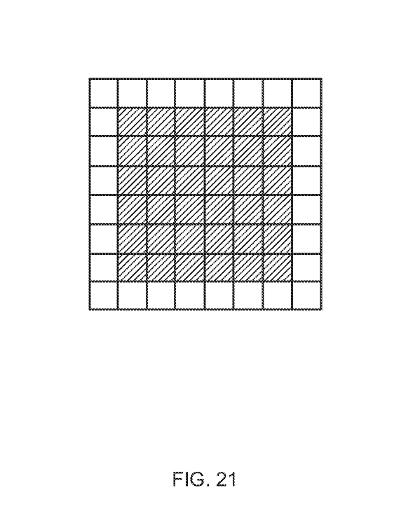

FIG. 21 depicts a reconstructed JPEG image using a region specific for image quality. In this figure, region which is not of interest, i.e. non-shaded region, is halved as compared to FIG. 10.

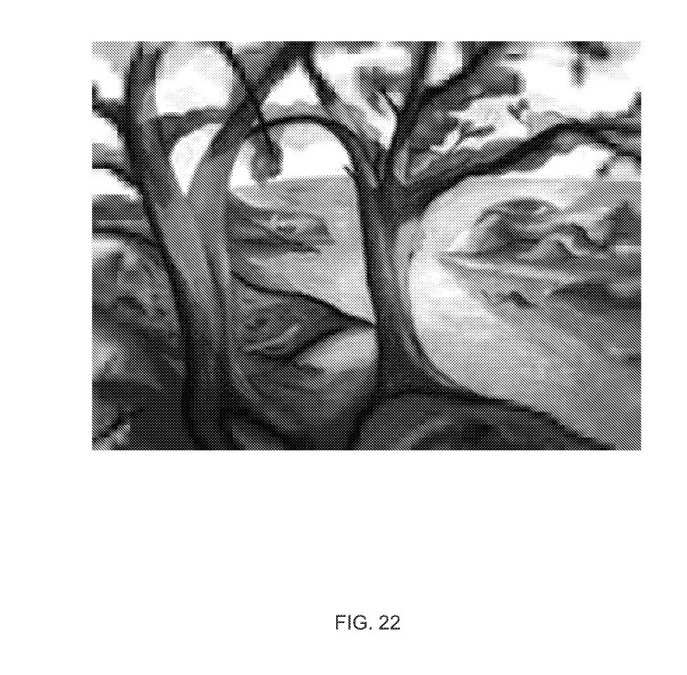

FIG. 22 further exemplifies the region of interest of FIG. 21.

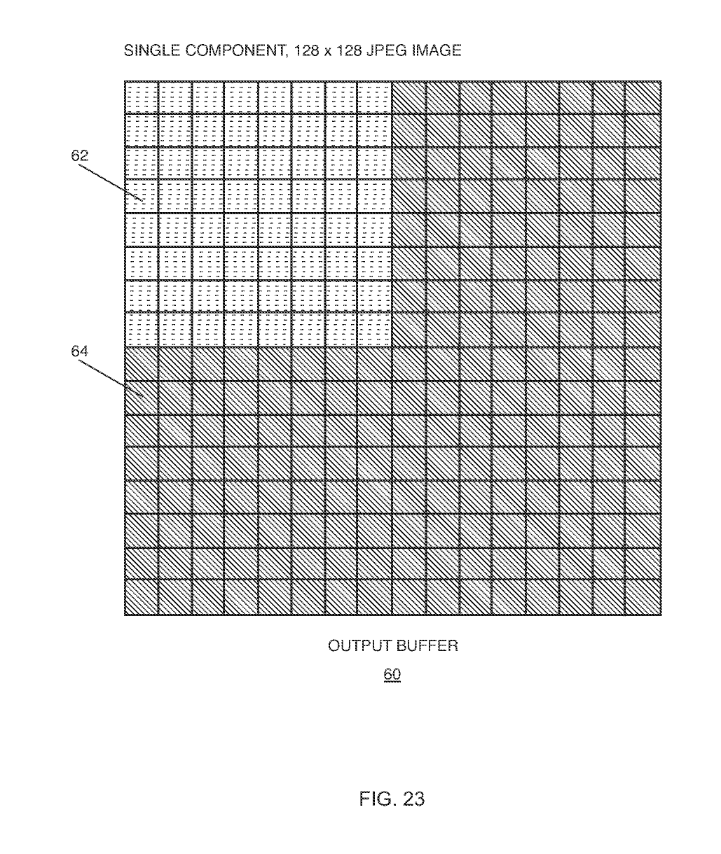

FIG. 23 shows Output Buffer 60 which stores N/4×M/4 approximate reconstruction of a JPEG image 62 and stored DCT coefficients 64.

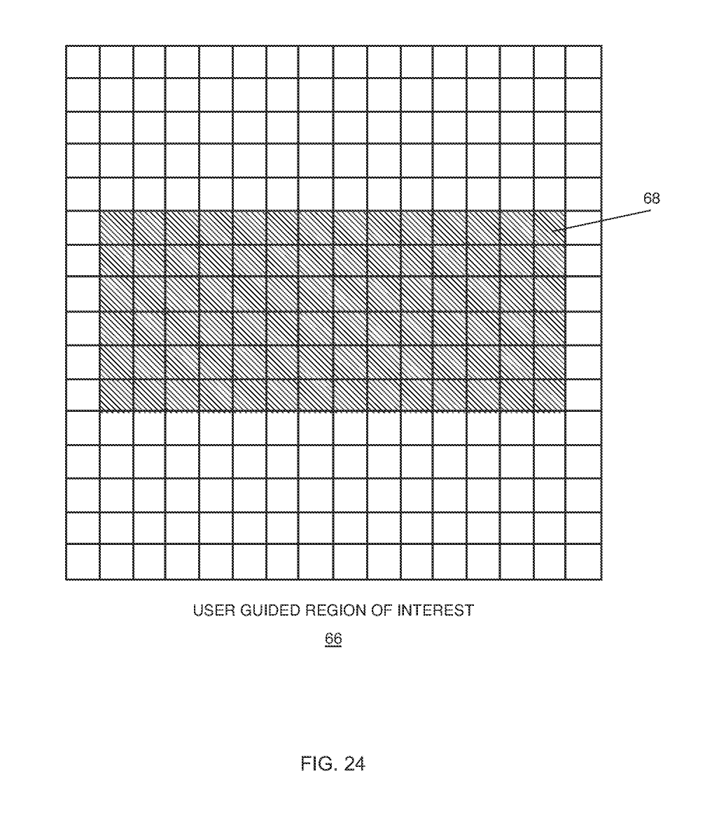

FIG. 24 shows a User guided ROI 66 which is of a Geometrical shaped ROI 68 and is drawn in a geometrical shape as chosen by user.

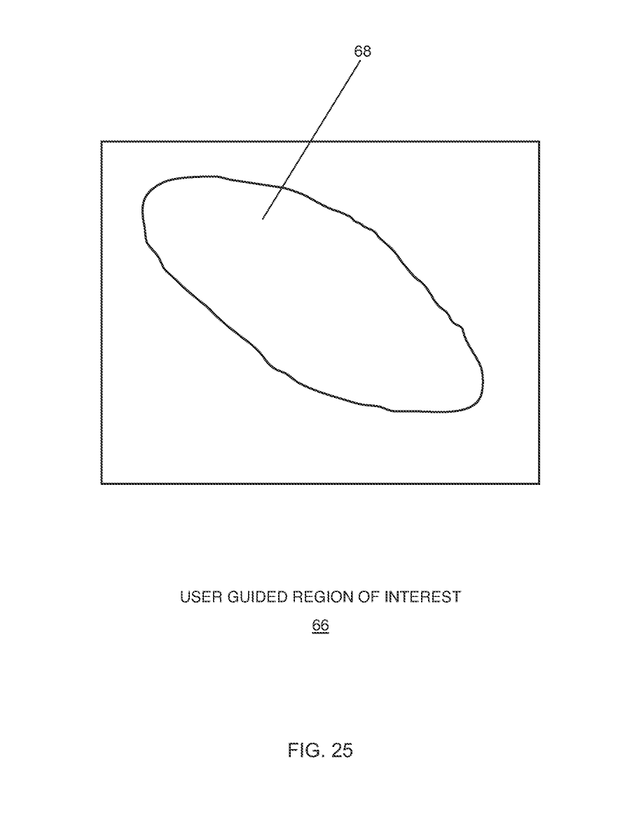

FIG. 25 shows a User guided ROI 66 which is drawn by user with a free hand 68. Data Units which are completely within the ROI are reconstructed with a relatively high quality

Although the disclosed method and apparatus is described above in terms of various exemplary embodiments and implementations, it should be understood that the various features, aspects and functionality described in one or more of the individual embodiments are not limited in their applicability to the particular embodiment with which they are described. Thus, the breadth and scope of the claimed invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Several embodiments are specifically illustrated and/or described herein. However, it will be appreciated that modifications and variations of the disclosed embodiments are covered by the above teachings and within the purview of the appended claims without departing from the spirit and intended scope of the invention.

1. A method for processing progressively encoded JPEG image, the method comprising:
decoding a sub-sampled approximation of the progressively encoded JPEG image;
up scaling the sub-sampled approximation;
storing a plurality of discrete cosine transform (DCT) coefficients of the sub-sampled approximation of the progressively encoded JPEG image;
reconstructing a complete JPEG image; and
reconstructing at least one region of interest of the JPEG image based on a region specific image quality.

2. The method of claim 1, wherein
the region specific image quality is produced according to a region specific inverse discrete cosine transform (IDCT) kernels and a plurality of region specific most significant bits (MSB's), of the plurality of DCT coefficients.

3. The method of claim 1, wherein the region of interest comprises a member from the group consisting of a quality of the JPEG image, a default region of interest and a user selected region of interest.

4. A system for processing progressively encoded JPEG image comprising:
a decoder operable to produce a sub-sampled approximation of the progressively encoded JPEG image;
a hardware up-scaling module for producing the sub-sampled approximation;
memory for storing a plurality of discrete cosine transform (DCT) coefficients of the sub-sampled approximation of the progressively encoded JPEG image; and
a reconstructing module for producing a complete JPEG image and at least one region of interest of the JPEG image based on a predetermined region specific image quality.

5. The system of method of claim 4, wherein the the region specific image quality is obtained by using a region specific inverse discrete cosine transform (IDCT) kernel and a plurality of region specific most significant bits (MSB's) of the plurality of DCT coefficients.

6. The system of claim 4, wherein the region of interest comprises a member from the group consisting of a quality of the JPEG image, a default region of interest and a user selected region of interest.

7. A non-transitory computer-executable storage medium comprising program instructions which are computer-executable to implement processing a progressively encoded JPEG image comprising:
program instructions that cause a sub-sampled approximation of the progressively encoded JPEG image be decoded;
program instructions that cause the sub-sampled approximation to be upscaled;
program instructions that cause a plurality of discrete cosine transform (DCT) coefficients of the sub-sampled approximation of the progressively encoded JPEG image be stored;
program instructions that cause a complete JPEG image be reconstructed; and
program instructions that cause a reconstruction at least one region of interest of the JPEG image based on a region specific image quality.

8. The non-transitory computer-executable storage medium of claim 7 wherein the region specific image quality is produced according to a region specific inverse discrete cosine transform (IDCT) kernel and a plurality of region specific most significant bits (MSB's) of the plurality of DCT coefficients.

9. The non-transitory computer-executable storage medium of claim 7, wherein the region of interest comprises a member from the group consisting of a quality of the JPEG image, a default region of interest and a user selected region of interest.

10. The method of claim 1, wherein the at least one region of interest is an array having dimensions equal to half of a height and half of a width of a data unit block.

11. The method of claim 1, wherein the at least one region of interest comprises one-fourth (¼) or less of the OCT coefficients present in a top-left four by four (4×4) array of an eight by eight (8×8) data unit block.

12. The method of claim 1, wherein decoding the sub-sampled approximation of the JPEG image comprises:
reducing an inverse discrete cosine transform (IDCT) kernel size; and
normalizing a result of the IDCT having reduced kernel size.

13. The system of claim 4, wherein the at least one region of interest is an array having dimensions equal to half of a height and half of a width of a data unit block.

14. The system of claim 4, wherein the at least one region of interest comprises one-fourth (¼) or less of the DCT coefficients present in a top-left four by four (4×4) array of an eight by eight (8×8) data unit block.

15. The system of claim 4, wherein decoder is operable to apply an inverse discrete cosine transform (IDCT) having a reduced kernel size, a result of the IDCT being normalized.

16. The non-transitory computer-executable storage medium of claim 7, wherein the at least one region of interest is an array having dimensions equal to half of a height and half of a width of a data unit block.

17. The non-transitory computer-executable storage medium of claim 7, wherein the at least one region of interest comprises one-fourth (¼) or less of the DCT coefficients present in a top-left four by four (4×4) array of an eight by eight (8×8) data unit block.

18. The non-transitory computer-executable storage medium of claim 7, wherein the program instructions which are computer-executable to implement processing comprise program instructions that cause an inverse discrete cosine transform (IDCT) to be applied, the IDCT having a reduced kernel size and a result of the IDCT being normalized.
